(19) United States
(12) Patent Application Publication
(10) Pub. No.: US 2010/0276567 A1
(43) Pub. Date: Nov. 4, 2010

(54) Two-Sided Ice Sculpture Mold with Flip-Lock Fasteners

(76) Inventor: Alistair MacAlister, Northboro, MA (US)

Correspondence Address: Russ Weinzimmer, 614 Nashua Street, Suite 53, Milford, NH, 03055, US

(21) Appl. No.: 12/431,877

(22) Filed: Apr. 29, 2009

(51) Int. Cl. B28B 7/34; B29C 33/20

(52) U.S. Cl. 249/134; 249/139

(57) ABSTRACT

A reusable, two-sided ice sculpture mold is disclosed that includes two halves made of a semi-rigid material such as plastic that resists deformation during freezing but provides sufficient flexibility to allow the mold to be separated from a finished ice sculpture by a slight flexing of the mold halves. A leak resistant seal is formed between the rims of the two halves by including a sealing gasket between the rims and by holding the rims firmly together using flip-lock fasteners that are located around the rims and are able to apply a substantially uniform sealing force. Preferred embodiments include an open base for filling and/or a gasket groove in the rim of one of the halves. The claimed mold is inexpensive to manufacture and includes only three parts that are easily separated and cleaned between uses.

### FIELD OF THE INVENTION

The invention generally relates to ice sculpture molds, and more specifically to reusable, two-sided ice sculpture molds.

### BACKGROUND OF THE INVENTION

Ice sculptures are an attractive and popular form of decoration. They can take on many shapes, and can be carved by hand or frozen in a mold. The use of an ice sculpture mold, in particular, can enable a relatively unskilled user to easily and conveniently production ice sculptures for informal and/or home use. In addition to water, fruit juices and other liquids can be formed into ice sculptures using an ice sculpture mold. For the sake of simplicity, however, all liquids suitable for freezing in an ice sculpture mold are referred to generically herein as “water,” and the frozen liquid that results is referred to as “ice.”

An ice sculpture mold must be able to contain water without leakage until the water is frozen. It must also provide a means for removal of the frozen sculpture from the mold without damage to the ice or to the mold. Many approaches have been suggested that attempt to address these requirements in different ways.

One approach is to provide an ice sculpture mold as a single piece that is typically open at one end, typically at the bottom. The mold is inverted, filled with water, and placed in a freezer. Once the ice has frozen, the sculpture is removed through the open bottom. This approach is easy to use and prevents leakage of the water before freezing. However, this approach severely limits the possible shape of the ice sculpture, since the sculpture must be able to slide out of the single-piece mold through the open bottom after freezing. Also, it is typically necessary to make single-piece molds out of a highly flexible material, so as to enable frozen sculptures to be broken free by flexing of the mold, and this often requires that the mold be supported in an inverted orientation during the freezing process by a separate stand, frame, or other structure, thereby increasing the expense and complexity of the molding apparatus.

Another approach is to use a disposable, single piece mold. After the ice is frozen, the mold is broken away from the ice, thereby releasing the sculpture. This approach allows a wider variety of shapes to be formed, but requires that a new mold be provided each time a new ice sculpture is to be manufactured. This approach can also require some sort of stand to support the mold in a desired orientation during the freezing process.

Many so-called “two-sided” ice sculpture molds include two halves that are held together during the freezing process and then separated from each other afterward so as to release the ice sculpture. While this approach allows a wider variety of ice sculpture shapes to be formed in a reusable mold, two-sided molds are generally susceptible to leakage of water through the joint formed between the two halves of the mold. Also, because ice expands during freezing, a two-sided mold must resist deformation and separation of the two halves during freezing, since this can potentially allow unfrozen water to leak out and/or cause distortion of the resulting ice sculpture.

One approach is to use rigid mold halves that can be sealed together using a sealing gasket, the mold halves being clamped together during the freezing process by any of a number of fastening means, such as nuts and bolts, removable clips, and such like. This approach can provide a good seal and resist expansion, but because the mold halves are rigid, they cannot be flexed so as to break free from a finished ice sculpture. A flexible liner can be provided so as to prevent ice from adhering to the rigid walls, but this increases the complexity and the number of parts required.

Another general approach is to use a flexible two-sided mold, typically made from plastic. Some two-part molds include a hinge that holds the two parts together. While this simplifies the use of the mold by reducing the number of parts and by automatically aligning the two halves when in use, the hinge can be difficult to clean, and the use of a hinge typically leads to an uneven application of force around the perimeter of the mold, and a correspondingly unequal seal between the two halves.

In some of these approaches, the two halves are held together during freezing by pressing a protrusion that surrounds the rim of one of the halves into a corresponding groove that is formed into the rim of the other half, thereby forming a watertight seal. However, this approach is typically limited to only very small molds, since for larger molds the two halves can pop apart due to ice expansion during freezing.

In similar approaches, the two halves are made from a flexible material, suitable for forming a gasket seal, and a protrusion surrounding the rim of one half is pressed in the manner of a gasket against a flat surface surrounding the rim of the other half. In these approaches, an additional means is included so as to hold the two halves together, such as removable clips, flip-lock fasteners, and the like. While this approach allows for easy removal of the sculpture by flexing of the mold halves, and resists leaking and popping apart due to ice expansion, the flexibility of the two halves of the mold can lead to distortion of the shape of the ice sculpture due to deformation of the mold by ice expansion.

### SUMMARY OF THE INVENTION

A reusable, two-sided ice sculpture mold is disclosed that includes two halves made of a material, such as a plastic, that is sufficiently rigid to resist deformation during freezing, while also being sufficiently flexible to allow the mold to be separated from a finished ice sculpture by a slight flexing of the mold halves. Because the material of the mold halves is too rigid to form a gasket seal, a separate sealing gasket, made from a suitable gasket material, is also provided so as to form a leak resistant seal between the rims of the two halves when the rims are held firmly together. Flip-lock fasteners located around the rims are used to hold the two halves together with a substantially uniform sealing force along the rims. Preferred embodiments include a gasket groove in the rim of one or both of the halves. The claimed mold is inexpensive to manufacture and includes only three parts that are easily separated and easily cleaned between uses.

One general aspect of the present invention is a reusable two-sided ice sculpture mold that includes two mold halves having complimentary rims that can be aligned against each other so as to form a molding volume therebetween, the two mold halves being sufficiently rigid to resist deformation due to expansion of ice freezing within the molding volume, while also being sufficiently flexible to allow separation of the mold halves from the ice by flexing the mold halves. The mold further includes a plurality of flip-lock fasteners disposed at locations along the rims of the two mold halves and configured so as to press the rims together with a pressing force that is substantially uniform around the rims, and a sealing gasket that can be placed between the rims of the two halves before pressing the rims together, so as to form a leak resistant seal therebetween.

In preferred embodiments, the two mold halves are made of plastic. In some preferred embodiments the flip-lock fasteners are attached to the rims of the two mold halves. In certain preferred embodiments the flip-lock fasteners are formed from the material of the two mold halves and extruded therefrom. And in various preferred embodiments at least one of the flip-lock fasteners includes a hinged flap extending from one of the mold halves, the hinged flap being engagable with a protrusion extending from the other mold half.

In preferred embodiments the rim of at least one of the two mold halves includes a groove formed therein so as to hold the sealing gasket in place when the rims of the two halves are pressed together. In some preferred embodiments the sealing gasket is made from an elastic material.

In various preferred embodiments the mold is configured so as to be containable within an interior of a household freezer. In some preferred embodiments at least one of the mold halves includes a hole through which water can be poured into the molding volume. And in other preferred embodiments notches are included in the rims of the mold halves and configured so as to form a hole when the mold halves are pressed together through which water can be poured into the molding volume.

Another general aspect of the present invention is a reusable two-sided ice sculpture mold. The mold includes two plastic mold halves having complimentary rims that can be aligned against each other so as to form a molding volume therebetween, the two mold halves being sufficiently rigid to resist deformation due to expansion of ice freezing within the molding volume, while also being sufficiently flexible to allow separation of the mold halves from the ice by flexing the mold halves. The mold also includes a plurality of flip-lock fasteners disposed at locations along the rims of the two mold halves and configured so as to press the rims together with a pressing force that is substantially uniform around the rims, the flip-lock fasteners being formed from the material of the two mold halves and extruded therefrom, and a sealing gasket that can be placed between the rims of the two halves before pressing the rims together, so as to form a leak resistant seal therebetween, the rim of at least one of the two mold halves including a groove formed therein so as to hold the sealing gasket in place when the rims of the two halves are pressed together.

In preferred embodiments at least one of the flip-lock fasteners includes a hinged flap extending from one of the mold halves, the hinged flap being engagable with a protrusion extending from the other mold half. In some preferred embodiments the sealing gasket is made from an elastic material.

In certain preferred embodiments the mold is configured so as to be containable within an interior of a household freezer. In other preferred embodiments at least one of the mold halves includes a hole through which water can be poured into the molding volume. And in various preferred embodiments notches are included in the rims of the mold halves and configured so as to form a hole when the mold halves are pressed together through which water can be poured into the molding volume.

### BRIEF DESCRIPTION OF THE DRAWINGS

The invention will be more fully understood by reference to the detailed description, in conjunction with the following figures, wherein:

FIG. 1A is an exploded view of a preferred embodiment showing the front half, the back half and the sealing gasket;

FIG. 1B is a perspective view of the embodiment of FIG. 1A with the mold assembled and ready for filling;

FIG. 1C is a top view of the assembled mold of FIG. 1B;

FIG. 2A is a close-up, cross-sectional view showing the rims of the two halves of an ice sculpture mold sealed to each other by a sealing gasket, in an embodiment where the edges of the rims are flat and the sealing gasket has a rectangular cross-section;

FIG. 2B is a close-up, cross-sectional view showing the edges of the two halves of an ice sculpture mold sealed to each other by a sealing gasket, in an embodiment where there is a notch in one of the edges and the sealing gasket has an oval cross-section;

FIG. 3A is a perspective view of the embodiment of FIG. 1A, showing the ice sculpture mold assembled, inverted, supported by the stand attached to its top, and being filled with water through its open base;

FIG. 3B is a perspective view of the embodiment of FIG. 3A, showing water frozen in the mold; and

FIG. 3C is a perspective view of the embodiment of FIG. 3B, showing an ice sculpture broken free from the ice sculpture mold.

### DETAILED DESCRIPTION OF PREFERRED EMBODIMENTS

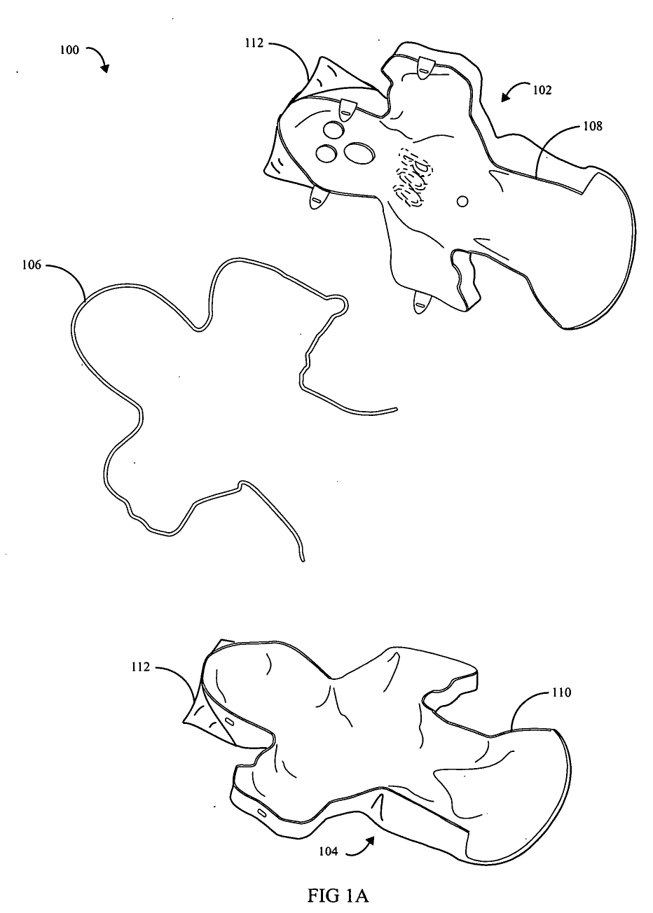

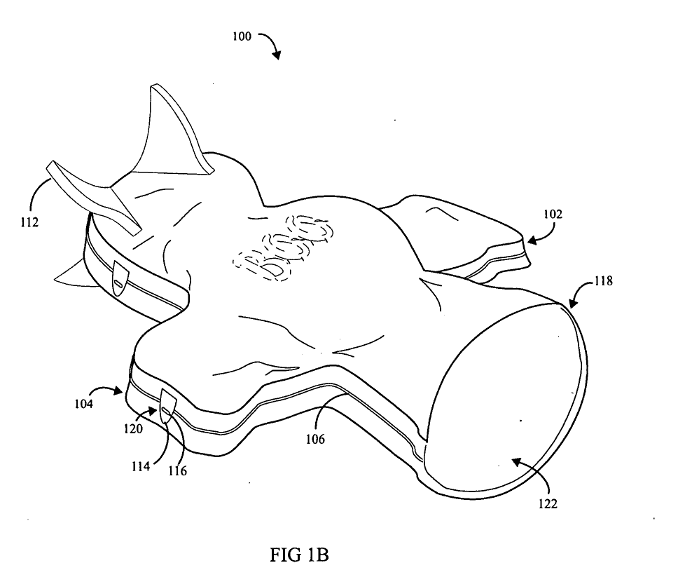

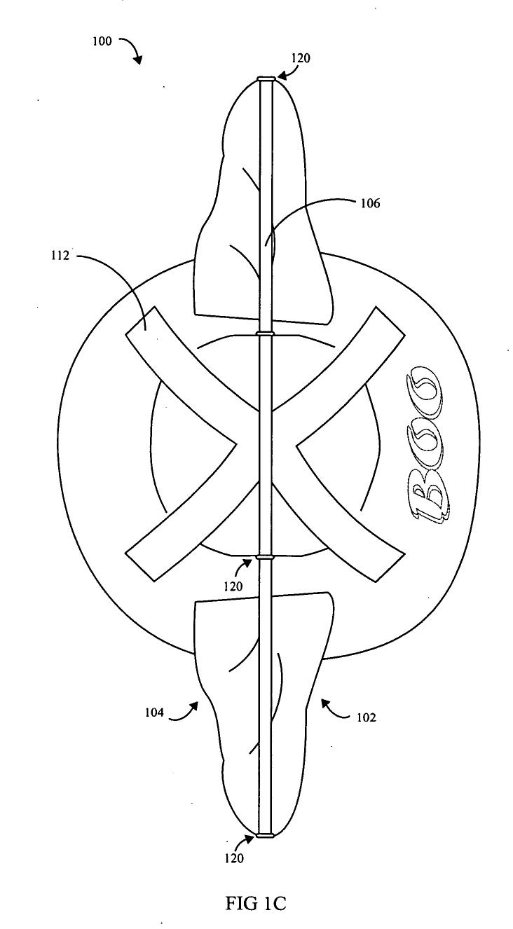

With reference to FIG. 1A, the present invention is a reusable, two-sided ice sculpture mold 100. The ice sculpture mold 100 includes a front half 102 and a back half 104 having complimentary rims 108, 110 with circumferences that can be aligned relative to each other. A sealing gasket 106 is configured so as to be insertable between the rims 108, 110 of the two halves 102, 104 and surround the entire circumference thereof.

FIG. 1B is a perspective view of the ice sculpture mold 100 of FIG. 1A after it has been assembled by placing the front half 102 on top of the back half 104 with the sealing gasket 106 in between, so as to form a molding volume 122 between the two halves 102, 104. A plurality of flip-lock fasteners 120 are attached to the two halves 102, 104 at locations surrounding the rims 108, 110 of the two halves 102, 104. For each flip-lock fastener 120 a buckle attached to one of the two mold halves 102, 104 cooperatively engages with a protrusion 116 extending from the other of the two mold halves 102, 104, thereby applying a sealing force that presses the two halves 102, 104 together. Flip-lock fasteners 120 are located at substantially regular intervals around the rims 108, 110 of the mold halves 102, 104, such that when all of the flip-lock fasteners are fastened the two mold halves 102, 104 are sealed together by a sealing force that is substantially uniform around the circumferences of the rims 108, 110. The bottom 122 of the mold 100 is open, and a stand 112 is provided at the top of the mold 100 so as to support the mold 100 in an inverted orientation during filling and freezing.

FIG. 1C is a top view of the assembled mold 100 of FIG. 1B, showing the configuration of the stand 112 when the mold 100 is assembled.

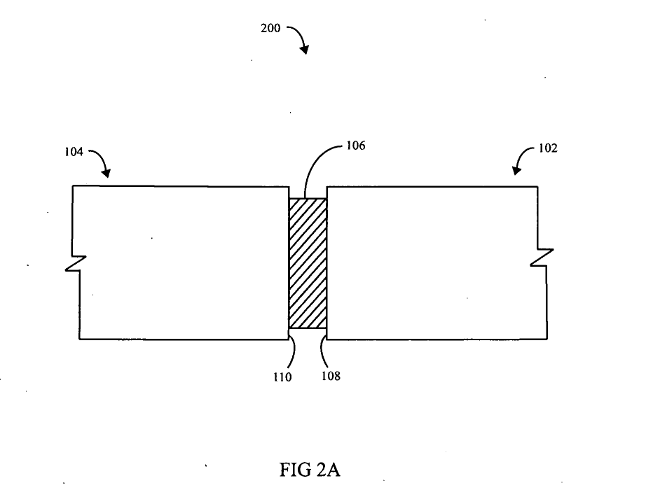

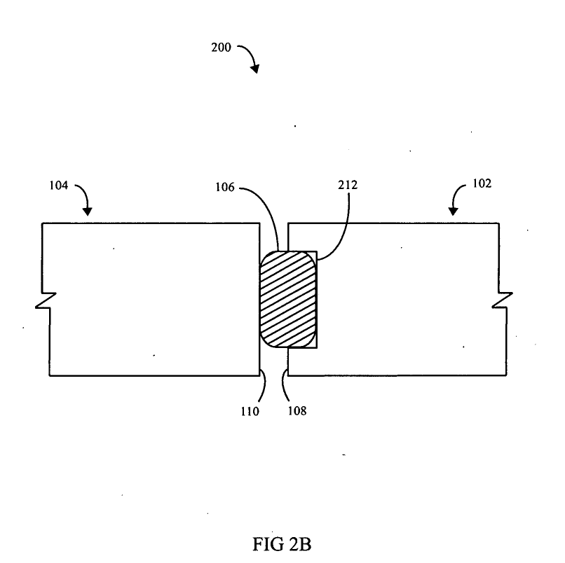

FIG. 2A is a close-up, cross-sectional view that shows the rims 108, 110 of the two halves 102, 104 of an ice sculpture mold sealed to each other by a sealing gasket 106 that forms a leak resistant seal between the two halves 102, 104 when the plurality of flip-lock fasteners 120 is fastened. In the embodiment of FIG. 1C, the rims 108, 110 have flat edges, and the sealing gasket has a rectangular cross-section.

FIG. 2B is a close-up, cross-sectional view of an embodiment similar to the embodiment of FIG. 2A, except that there is a notch 212 in one of the rims 108, and the sealing gasket 106 has a round or oval cross-section. The sealing gasket 106 fits into the groove 124, which holds the gasket 106 in place when the rims 108, 110 of the two mold halves 102, 104 are pressed against each other. In similar embodiments, both rims 108, 110 include notches 212.

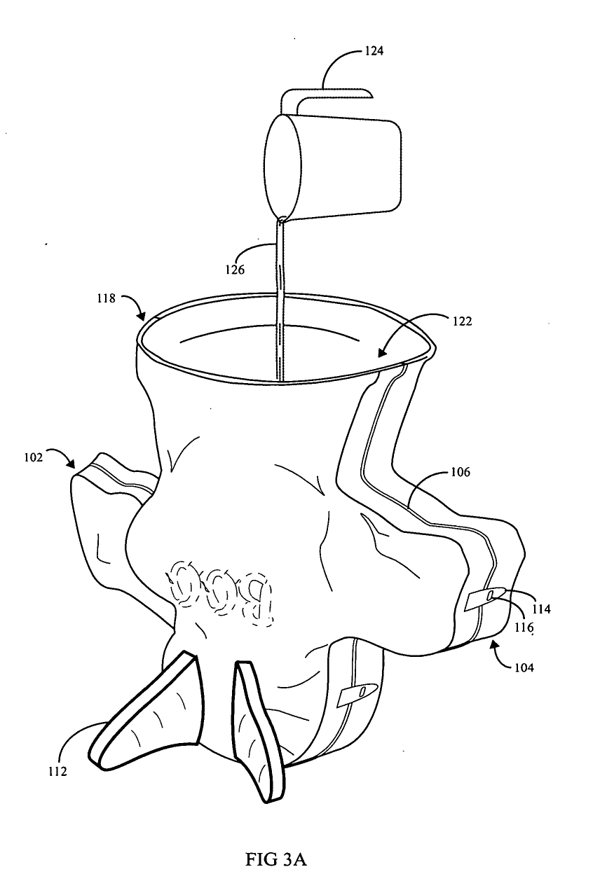

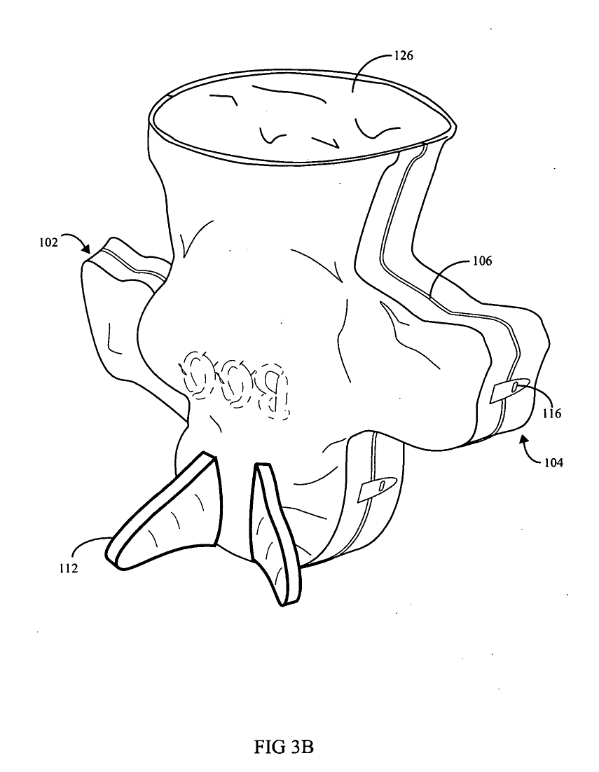

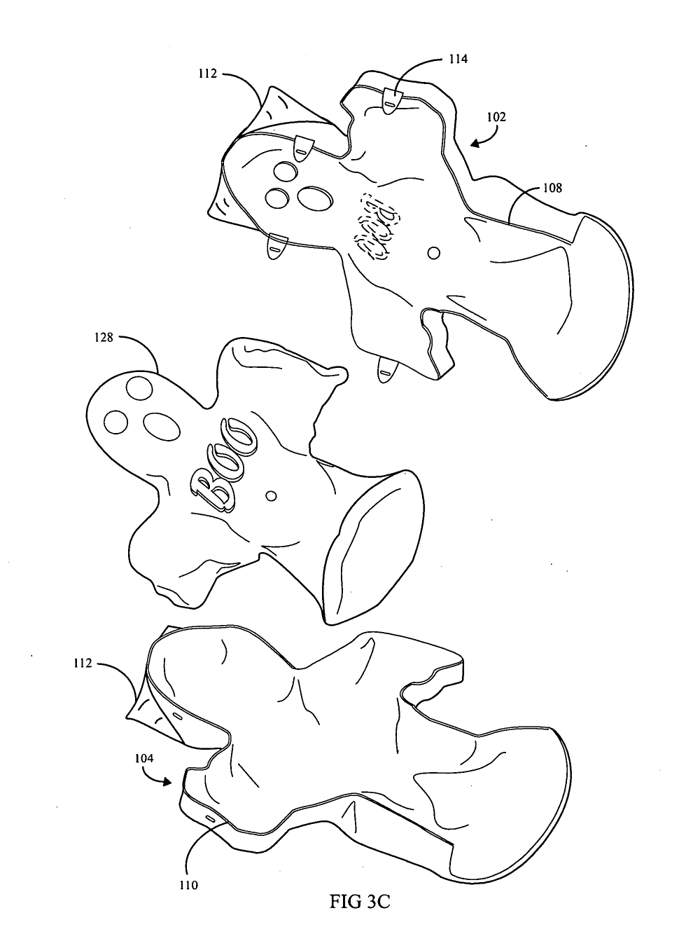

FIG. 3A is a perspective view of the ice sculpture mold 100 of FIG. 1A showing water or some other freezable liquid 126 being poured from a measuring cup 124 into the molding volume 122 formed when the two halves 102, 104 of the mold 100 are sealed together. While it is being filled, the ice sculpture mold 100 is inverted and supported by the stand 112 attached to the top of the mold 100. The freezable liquid 126 is poured through the open base 122 of the ice sculpture mold 100.

FIG. 3B is a perspective view of the ice sculpture mold 100 of FIG. 3A after the mold 100 has been filled with water 126 and then placed in a cold environment such as a household freezer so as to allow the water or other freezable liquid 126 to freeze.

FIG. 3C is a perspective view of an ice sculpture 128 after the two halves 102, 104 of the ice sculpture mold 100 have been separated, and the resulting ice sculpture 128 has been broken free from the ice sculpture mold 100. The two halves 102, 104 of the mold 100 are made from a semi-rigid material, which in preferred embodiments is a plastic, that resists deformation due to ice expansion but provides sufficient flexibility to allow a newly frozen ice sculpture 128 to be broken free from the two halves 102, 104 of the mold 100 by a slight flexing of the two halves 102, 104.

Other modifications and implementations will occur to those skilled in the art without departing from the spirit and the scope of the invention as claimed. Accordingly, the above description is not intended to limit the invention except as indicated in the following claims.

What is claimed is:

1. A reusable two-sided ice sculpture mold comprising:
two mold halves having complimentary rims that can be aligned against each other so as to form a molding volume therebetween, the two mold halves being sufficiently rigid to resist deformation due to expansion of ice freezing within the molding volume, while also being sufficiently flexible to allow separation of the mold halves from the ice by flexing the mold halves;
a plurality of flip-lock fasteners disposed at locations along the rims of the two mold halves and configured so as to press the rims together with a pressing force that is substantially uniform around the rims; and
a sealing gasket that can be placed between the rims of the two halves before pressing the rims together, so as to form a leak resistant seal therebetween.

2. The ice sculpture mold of claim 1, wherein the two mold halves are made of plastic.

3. The ice sculpture mold of claim 1, wherein the flip-lock fasteners are attached to the rims of the two mold halves.

4. The ice sculpture mold of claim 1, wherein the flip-lock fasteners are formed from the material of the two mold halves and extruded therefrom.

5. The ice sculpture mold of claim 1, wherein at least one of the flip-lock fasteners includes a hinged flap extending from one of the mold halves, the hinged flap being engagable with a protrusion extending from the other mold half.

6. The ice sculpture mold of claim 1, wherein the rim of at least one of the two mold halves includes a groove formed therein so as to hold the sealing gasket in place when the rims of the two halves are pressed together.

7. The ice sculpture mold of claim 1, wherein the sealing gasket is made from an elastic material.

8. The ice sculpture mold of claim 1, wherein the mold is configured so as to be containable within an interior of a household freezer.

9. The ice sculpture mold of claim 1, wherein at least one of the mold halves includes a hole through which water can be poured into the molding volume.

10. The ice sculpture mold of claim 1, wherein notches are included in the rims of the mold halves and configured so as to form a hole when the mold halves are pressed together through which water can be poured into the molding volume.

11. A reusable two-sided ice sculpture mold comprising:
two plastic mold halves having complimentary rims that can be aligned against each other so as to form a molding volume therebetween, the two mold halves being sufficiently rigid to resist deformation due to expansion of ice freezing within the molding volume, while also being sufficiently flexible to allow separation of the mold halves from the ice by flexing the mold halves;
a plurality of flip-lock fasteners disposed at locations along the rims of the two mold halves and configured so as to press the rims together with a pressing force that is substantially uniform around the rims, the flip-lock fasteners being formed from the material of the two mold halves and extruded therefrom; and
a sealing gasket that can be placed between the rims of the two halves before pressing the rims together, so as to form a leak resistant seal therebetween,
the rim of at least one of the two mold halves including a groove formed therein so as to hold the sealing gasket in place when the rims of the two halves are pressed together.

12. The ice sculpture mold of claim 11, wherein at least one of the flip-lock fasteners includes a hinged flap extending from one of the mold halves, the hinged flap being engagable with a protrusion extending from the other mold half.

13. The ice sculpture mold of claim 11, wherein the sealing gasket is made from an elastic material.

14. The ice sculpture mold of claim 11, wherein the mold is configured so as to be containable within an interior of a household freezer.

15. The ice sculpture mold of claim 11, wherein at least one of the mold halves includes a hole through which water can be poured into the molding volume.

16. The ice sculpture mold of claim 11, wherein notches are included in the rims of the mold halves and configured so as to form a hole when the mold halves are pressed together through which water can be poured into the molding volume.
